(19) United States
(12) Patent Application Publication
(10) Pub. No.: US 2018/0158071 A1
(43) Pub. Date: Jun. 7, 2018

(54) System for Tracking and Authenticating an Item

(71) Applicant: Polestar LTD LLC, Proctorsville, VT (US)

(72) Inventor: Wendell M. Smith, Lebanon, NH (US)

(21) Appl. No.: 15/833,652

(22) Filed: Dec. 6, 2017

Related U.S. Application Data
(60) Provisional application No. 62/430,647, filed on Dec. 6, 2016.

(51) Int. Cl. G06Q 30/00; G06K 7/14; G06K 19/06; G06F 17/30

(52) U.S. Cl. CPC G06Q 30/018; G06F 17/30964; G06K 19/06028; G06K 7/1413

(57) ABSTRACT

A system for tracking and authenticating an item includes a database for storing a plurality of digital files each corresponding to a physical item. Each digital file includes information for a machine-readable code, a forensic element, and parameters for time, date, and location for the physical item. The system includes a scanner for scanning the machine-readable code of an item presented for verification, and an analyzer for analyzing the forensic element of the item presented for verification. A controller is in communication with the database, the scanner, and the analyzer. The controller has software to receive the machine-readable code from the scanner to retrieve an item identity from the database, receive the forensic element from the analyzer to authenticate the item presented for verification, and receive tracking data when the physical item is analyzed or scanned to verify the tracking data using the database.

### TECHNICAL FIELD

The present disclosure relates generally to a system for tracking and authenticating an item, and more particularly to a system for tracking and authenticating an item having a forensic element.

### BACKGROUND

Bar codes are used in almost every industry and business today as a means of tracking objects. Bar codes can be used to prevent diversion and counterfeiting by providing a standardized system for authentication. A variety of systems incorporating bar codes and similar encoding systems protect people from the harms of counterfeit products. Similarly, they provide organizations such as governments, major industries, or individual companies with a means of tracking items, both digital and physical, as they move around the globe or from person to person. The ability to self-authenticate items, e.g. for a consumer to verify the authenticity and security of a package received in the mail, has become increasingly important. Despite a growing need for systems enabling self-authentication, i.e. for users to authenticate items themselves, many of the current tracking systems do not provide self-authentication, or lack sophistication.

The use of various types of DNA tagged inks to track a physical item is well known in the art, and was described in U.S. Pat. No. 6,030,657 (“Butland”). This was improved upon by U.S. Pat. No. 6,612,494 (“Outwater”), which incorporated the use of DNA tagged inks into a system involving storing and retrieving spectral data. Outwater also disclosed how to embed the DNA tagged inks into the background of a label, and how to surround a barcode with the DNA tagged inks. DNA tagged inks were also incorporated into Document Security system patents such as U.S. Pat. No. 8,040,541 (“Smith”). However, the prior systems fail to provide a system capable of incorporating multiple forms of verification such that self-authentication is layered into the overall system to provide increased efficiency without sacrificing reliability.

Aspects of the present invention are directed to these and other problems.

### SUMMARY OF THE INVENTION

According to an aspect of the present invention, a system for tracking and authenticating an item includes a database for storing a plurality of digital files each corresponding to a physical item. Each of the plurality of digital files including information for a machine-readable code for identifying the physical item, information identifying a forensic element on the physical item for authenticating the physical item, and information defining parameters for at least one of time, date, and location data for the physical item. The system also includes a device for marking the physical item according to information from one of the plurality of digital files corresponding to the physical item. The system includes a scanner for scanning the machine-readable code of an item presented for verification, and an analyzer for analyzing the forensic elements of the item presented for verification. A controller in communication with the database, the scanner, and the analyzer includes software executing on the controller for receiving the machine-readable code from the scanner and using it to retrieve an item identity from the database. In addition, the controller also has software executing on the controller for receiving the forensic element from the analyzer and using it to authenticate the item presented for verification using the database, and software executing on the controller for receiving tracking data when the physical item is analyzed or scanned, and verifying the tracking data using the database.

According to another aspect of the present invention, a system for tracking and authenticating an item includes a database for storing a digital file corresponding to a physical item. The digital file has information for identifying and authenticating the physical item, including information for a machine-readable code, information for a forensic element, and information defining time, date, and location parameters. The system includes a scanner for scanning the machine-readable code of an item presented for verification and for collecting tracking data of the item presented for verification at the time it is scanned. The system includes an analyzer for analyzing the forensic element of the item presented for verification, and a controller in communication with the database, the scanner, and the analyzer. The controller includes software executing on the controller for receiving the machine-readable code from the scanner and using it to retrieve an item identity from the database, software executing on the controller for receiving the forensic element from the analyzer and using it to authenticate the item presented for verification using information from the database, and software executing on the controller for receiving tracking data when the physical item is scanned, and verifying the tracking data using information from the database.

According to another aspect of the present invention, a method of tracking and authenticating an item includes the steps of a first user creating a digital file and storing it in a database, the digital file having information that associates a physical item with a machine-readable code, a forensic element, and parameters for at least one of time, date, and location data. Transmitting the digital file from the database to a device where it is used to mark the physical item with the machine-readable code and the forensic element corresponding to the physical item. The first user transferring the physical item to a second user. The second user scanning the physical item with a scanner that sends information including the scanned machine-readable code and tracking data of the physical item to a controller where software executing on the controller authenticates the physical item by comparing the information received from the scanner with information in a digital file corresponding to the physical item obtained from the database. The second user analyzing the physical item with an analyzer that sends information including the analyzed forensic element to the controller where software executing on the controller authenticates the physical item by comparing the information received from the analyzer with information in the digital file corresponding to the physical item obtained from the database.

In addition to, or as an alternative to, one or more of the features described above, further aspects of the present invention can include one or more of the following features, individually or in combination:
the software executing on the controller upon receiving the tracking data compares the tracking data against the information in at least one of the plurality of digital files defining parameters for at least one of time, date, and location data for the physical item;
at least one of the physical item, the machine-readable code, and the forensic element, further comprises a spectral taggant having a unique emission spectrum;
the scanner or the analyzer comprises an exciter for irradiating the spectral taggant to render it readable, and the exciter is configured to produce at least one of gamma rays, x-rays, UV rays, visible light, infrared light, microwaves, or radio waves;
the device for marking the physical item comprises a printer that applies the machine-readable code to the physical item;
the printer also applies the forensic element to the physical item;
the machine-readable code is a bar code;
the forensic element comprises biometric data;
the analyzer collects tracking data of the item presented for verification at the time it is analyzed;
software executing on the controller for receiving the tracking data when the physical item is analyzed, and verifying the tracking data using information from the database;
the information defining time, date, and location parameters includes a date and a location, and the physical item is permitted to be in the location on the date;
the information defining time, date, and location parameters includes a list of locations, and the physical item is permitted to be in any location on the list of locations on any date;
the information defining time, date, and location parameters includes a date range, and the physical item is permitted to be in any location during the date range;
the tracking data includes the current date, time, and location of the item presented for verification.

These and other aspects of the present invention will become apparent in light of the drawings and detailed description provided below.

### BRIEF DESCRIPTION OF THE DRAWINGS

FIG. 1 is a block diagram of a system for tracking and authenticating an item according to the present invention.

FIG. 2 is a block diagram of the system of FIG. 1 including additional detail.

FIG. 3 is a flow diagram of a method for tracking and authenticating an item according to the present invention.

### DETAILED DESCRIPTION

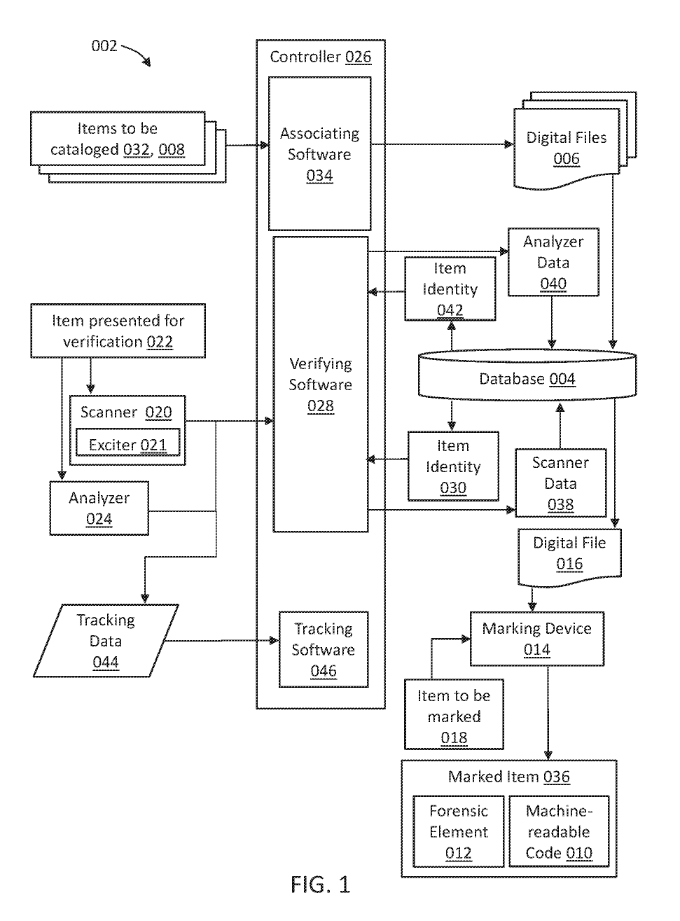

Referring to FIG. 1, the present disclosure describes a system and method for tracking and authenticating an item. The authentication system 002 includes a database 004 for storing a plurality of digital files 006. Each of the plurality of digital files 006 corresponds to a physical item 008, and associates the physical item 008 with a machine-readable code 010 and a forensic element 012. A marking device 014 receives a digital file 016 corresponding to an item to be marked 018, and then marks the item to be marked 018 with the machine-readable code 010 and the forensic element 012 indicated by the digital file 016. During the verification process, a scanner 020 scans the machine-readable code 010 of an item presented for verification 022, and an analyzer 024 analyzes the forensic element 012 of the item presented for verification 022. A controller 026 is in communication with the database 004, the scanner 020, and the analyzer 024. Verifying software 028 executing on the controller 026 receives the machine-readable code 010 from the scanner 020 and uses it to retrieve the item identity 030 from the database 004. Verifying software 028 executing on the controller 026 receives the forensic element 012 from the analyzer 024 and uses it to authenticate the item presented for verification 022.

Still referring to FIG. 1, information pertaining to items to be catalogued 032 is sent to the controller 026 where it is received by associating software 034. The associating software 034 associates each of the items to be catalogued 032 with a machine-readable code 010 (not shown) and forensic element 012 (not shown), and places the information associating each of the items to be catalogued 032 with its machine-readable code 010 and forensic element 012 in a digital file 006, and then sends the digital file 006 to the database 004.

Still referring to FIG. 1, during the marking process, the database 004 sends a digital file 016 to a marking device 014 that corresponds to an item to be marked 018. The marking device 014 marks the item to be marked 018 with the appropriate machine-readable code 010 and forensic element 012 as indicated by the digital file 016, and the marked item 036 is then output from the marking device 014. The marked item 036 can now be distributed, sold, or transferred. In one embodiment, the marking device 014 is a printer capable of printing a forensic security ink, or an ink having one or more forensic elements 012 in it, as well as printing bar codes on the item to be marked 018.

Still referring to FIG. 1, during the verification process an item presented for verification 022 is scanned with a scanner 020, which reads the machine-readable code 010 of the item presented for verification 022. The output information from the scanner 020 is sent to the verifying software 028 executing on the controller 026, and the verifying software 028 sends scanner data 038 to the database 004 and retrieves the corresponding item identity 030 from the database 004. Also part of the verification process, the item presented for verification 022 is analyzed by analyzer 024, which analyzes the forensic element 012 of the item presented for verification 022. The output information from the analyzer 024 is sent to the verifying software 028 executing on the controller 026, and the verifying software 028 sends analyzer data 040 to the database 004 and retrieves the corresponding item identity 042.

In one embodiment, the machine-readable code 010 and/or the forensic element 012 and/or the material of the marked item 036 includes one or more taggants as an additional means of verification. Taggants are anything that can be used to identify an object, and includes molecular taggants as well as spectral taggants. Molecular taggants are generally not identifiable in the field since they require the use of a forensic lab to be identified, and incorporates the use of components such as DNA. Spectral taggants are generally identifiable in the field, and indicate the use of something having a unique optical feature, such as an emission spectrum, which is detected using either the scanner 020 or the analyzer 024. The unique emission spectrum may have multiple parts, and may only be detectable in certain portions of the electromagnetic spectrum, e.g. gamma ray, x-ray, UV, visible, infrared, microwave, or radio. The spectral taggant may need to be irradiated by light from a particular portion of the electromagnetic spectrum, e.g. gamma rays, x-rays, UV rays, visible light, infrared light, microwaves, or radio waves; and the irradiation may come from an exciter 021.

Still referring to FIG. 1, the exciter 021 is a device that creates the optical effect in the spectral taggants, which is perceived by the scanner 020 or the analyzer 024. The exciter 021 may be integrated into the scanner 020 or the analyzer 024, or exist on its own. In a related embodiment, the scanner 020, the analyzer 024, and the exciter 021 are integrated into one hand-held device, such as a smart phone. The portion(s) of the electromagnetic spectrum that the emission spectrum is found in may directly correspond to, or be completely unrelated to, the portion(s) of the electromagnetic spectrum emitted by the exciter 021. In a related embodiment, the scanner 020, the analyzer 024, or the exciter 021 can be a smart-phone-enabled device, or even the phone itself. For example, the screen or the camera light can function as the exciter 021, and the camera can serve as the scanner 020 or the analyzer 024. The scanner 020 may detect both visible and invisible codes printed on the object. In other embodiments, the forensic element 012 can be any type of biometric information including a finger print, voice wave, retina/iris scan, earlobe geometry, DNA, RNA, vascular structure, pigmentation, or combinations thereof; as well as other identifying information such as a high resolution photograph, amino acids, proteins, organic molecules, unicellular organisms, or genomic sequences, and combinations thereof; it can include synthetic and/or naturally occurring types of these things, any combinations of the above-mentioned examples, or any other similar metrics known by those of skill in the art. The forensic element 012 may only be readable by an analyzer 024 found in a forensic lab, such as a DNA sequencer, NMR instrument, chromatography instrument, or (x-ray) crystallography instrument.

Still referring to FIG. 1, during the tracking process, tracking data 044 is sent to tracking software 046. Tracking software 046 may also be a part of/the same as the verifying software 028 although not depicted this way in FIG. 1. The tracking data 044 is part of the verification process. When the digital file 006 is stored, it includes allowable parameters for time, date, and location for a physical item 008. The verifying software 028 retrieves information from the digital file 006 stored in the database 004 in order to verify that the tracking data 044 matches the parameters defined in the digital file 006. If the tracking data 044 indicates the item was scanned or analyzed outside of the allowable parameters, the verifying software 028 returns a null value or a failed authentication. The tracking data 044 may include time, date, and location information generated at the time when the item presented for verification 022 is either scanned by the scanner 020 or analyzed by the analyzer 024. In other embodiments, the tracking software 046 can retrieve one of the plurality of digital files 006 associated with the tracking data 044 from the database 004, and update that digital file 006 with the tracking data 044 before returning it to the database. Once the tracking data 044 has been added to the digital file 006, this information may serve a number of functions. The tracking data 044 may become part of the verification process, or it may be accessed by a user to inform them where a physical item 008 has been. In another embodiment, an automatic scanner 020 is set up as part of a conveyor belt to generate tracking data 044 as each item presented for verification 022 goes by. This data can then be accessed by a manufacturer, author, or end user to check the location of an item in real time, e.g. to allow a consumer to see where a package they purchased is currently located in its delivery process. The system can be set up to automatically send a notification if the tracking data 044 does not meet preset conditions for that item.

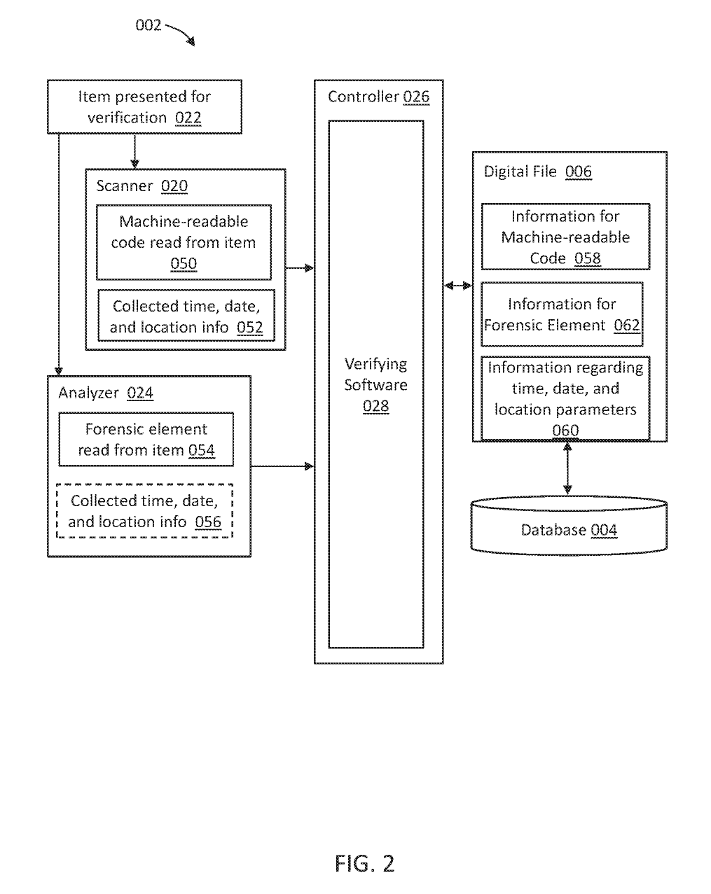

Referring to FIG. 2, an authentication system 002 is shown. This figure details the verification portion of the invention, and assumes the item has already been labeled with the machine-readable code 010 and forensic element 012, and has already been cataloged with a corresponding digital file having been created. One aspect of the authentication system 002 as shown in FIG. 2 involves analyzing the item presented for verification 022. The item 022 is provided to the analyzer 024, which reads the machine-readable code from the item 050. The analyzer 024 may also collect the time, date, and location information 052 simultaneously or nearly simultaneously with the reading of the code. This information is then provided to the controller 026. The controller then requests the digital file 006 corresponding to the machine-readable code 050 from the database 004 where the digital files 006 are stored. The digital file 006 includes information for the machine-readable code 058 such that the information received from the analyzer 024 can be verified for its authenticity by the verifying software 028. In addition, the digital file 006 includes information regarding time, date, and location parameters 060, so that the verifying software 028 can check that the collected time, date and location information 052 is within the parameters 060. This verifies that the item is authorized to be in that location at that time and date.

Still referring to FIG. 2, another aspect of the authentication system 002 as shown in FIG. 2 involves scanning the item presented for verification 022. The item 022 is provided to the scanner 020, which scans the item to produce the forensic element read from the item 054. In some embodiments, the scanner 020 may also collect time, date, and location information 056 simultaneously or nearly simultaneously with the scanning of the forensic element 054. This information is sent from the scanner 020 to the controller 026. The controller 026 then requests the digital file 006 corresponding to the forensic element 054 from the database 004 where the digital files 006 are stored. The digital file 006 includes information for the forensic element 062 such that the information received from the scanner 020 can be verified for its authenticity by the verifying software 028. In addition, the digital file 006 includes information regarding time, date, and location parameters 060, so that the verifying software 028 can check that the collected time, date and location information 056 is within the parameters 060. This verifies that the item is authorized to be in that location at that time and date.

In one embodiment, the information regarding time, date, and location parameters 060 can include: an address, town, state, region, country, latitude & longitude, or building where the item is permitted to be for a given date and time or a given date range; a sequence of permitted places and dates or date ranges for the item as it is conveyed from one place to another; a list of places where the item is permitted to be at any time; a list of dates where the item is permitted to be anywhere; similar data known by those of skill in the art familiar with the present disclosure; or some combination thereof. The tracking data 044 of FIG. 1, as well as the collected time, date, and location information 052, 056 of FIG. 2, vary in accordance with the information regarding time, date, and location parameters 060 that are actually stored.

In some embodiments, if the verifying software 028 does not verify that the collected time, date, and location information 052, 056 match (i.e. are within the allowable ranges for) the time, date, and location parameters 060, the system 002 will not proceed to verify the forensic element read from the item 054 or the machine-readable code read from the item 050. In other embodiments, the system 002 will operate as normal in verifying the other aspects of the item presented for verification 022, but the controller 026 will send a notification message to a third party to inform them that the item is not where it should be, e.g. a private alert message to a manufacturer that their shipped item has gone astray.

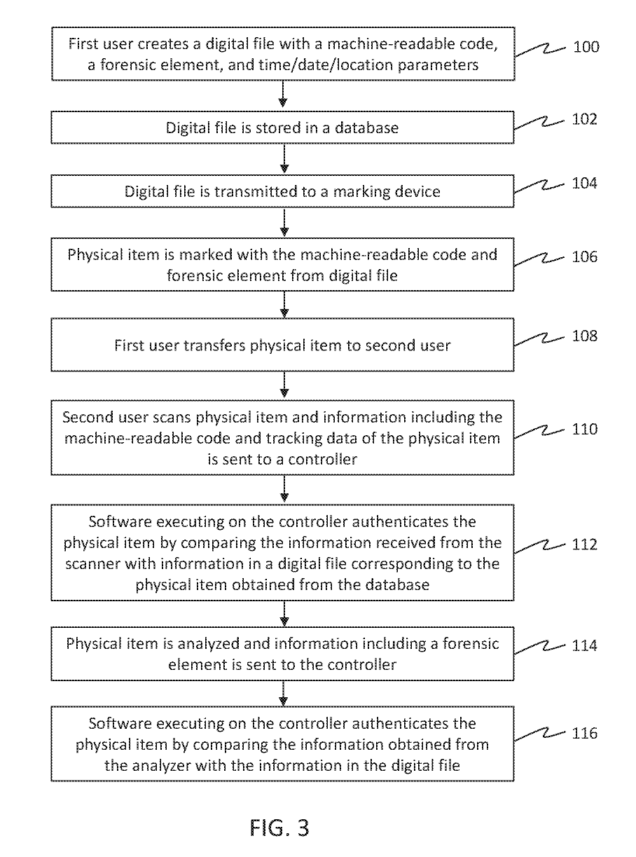

In the illustrated embodiment of FIG. 3, a first user creates a digital file with a machine-readable code, a forensic element, and time/date/location parameters 100. The digital file is then stored in a database 102. The digital file is transmitted to a marking device 104. The marking device uses the information in the digital file to mark a physical item with the machine-readable code and forensic element from the digital file 106. Once the item is marked, the first user transfers the item to a second user 108, e.g. a seller ships a purchased item to a buyer. The second user scans the physical item and information including the machine-readable code and tracking data (e.g. the current time/date/location data) of the physical item is sent to a controller 110. Software executing on the controller authenticates the physical item by comparing the information received from the scanner with information in a digital file corresponding to the physical item obtained from the database 112. The physical item is analyzed and information including a forensic element is sent to the controller 114. Software executing on the controller authenticates the physical item by comparing the information obtained from the analyzer with the information in the digital file 116. In further embodiments, messages indicating the success or failure of the verification process can be sent after various steps, such as after the item identity is obtained from the database in step 112, or after the item is authenticated in step 116.

While several embodiments have been disclosed, it will be apparent to those of ordinary skill in the art that aspects of the present invention include many more embodiments and implementations. Accordingly, aspects of the present invention are not to be restricted except in light of the attached claims and their equivalents. It will also be apparent to those of ordinary skill in the art that variations and modifications can be made without departing from the true scope of the present disclosure. For example, in some instances, one or more features disclosed in connection with one embodiment can be used alone or in combination with one or more features of one or more other embodiments.

What is claimed is:

1. A system for tracking and authenticating an item, comprising:
a database for storing a plurality of digital files each corresponding to a physical item, each of the plurality of digital files including information for a machine-readable code for identifying the physical item, information identifying a forensic element on the physical item for authenticating the physical item, and information defining parameters for at least one of time, date, and location data for the physical item.

2. The system of claim 1, further comprising:
a device for marking the physical item according to information from one of the plurality of digital files corresponding to the physical item;
a scanner for scanning the machine-readable code of an item presented for verification;
an analyzer for analyzing the forensic elements of the item presented for verification;
a controller in communication with said database, said scanner, and said analyzer;
software executing on said controller for receiving the machine-readable code from said scanner and using it to retrieve an item identity from said database;
software executing on said controller for receiving the forensic element from said analyzer and using it to authenticate the item presented for verification using said database; and
software executing on said controller for receiving tracking data when the physical item is analyzed or scanned, and verifying the tracking data using said database.

3. The system of claim 2, wherein the software executing on said controller upon receiving the tracking data compares the tracking data against the information in at least one of the plurality of digital files defining parameters for at least one of time, date, and location data for the physical item.

4. The system of claim 3, wherein at least one of the physical item, the machine-readable code, and the forensic element, further comprises a spectral taggant having a unique emission spectrum.

5. The system of claim 4, wherein the scanner or the analyzer comprises an exciter for irradiating the spectral taggant to render it readable; and
the exciter is configured to produce at least one of gamma rays, x-rays, UV rays, visible light, infrared light, microwaves, or radio waves.

6. The system of claim 2, wherein the device for marking the physical item comprises a printer that applies the machine-readable code to the physical item.

7. The system of claim 6, wherein the printer also applies the forensic element to the physical item.

8. The system of claim 1, wherein the machine-readable code is a bar code.

9. The system of claim 1, wherein the forensic element comprises biometric data.

10. A system for tracking and authenticating an item, comprising:
a database for storing a digital file corresponding to a physical item, the digital file including information for identifying and authenticating the physical item, including information for a machine-readable code, information for a forensic element, and information defining time, date, and location parameters;
a scanner for scanning the machine-readable code of an item presented for verification and for collecting tracking data of the item presented for verification at the time it is scanned;
an analyzer for analyzing the forensic element of the item presented for verification;
a controller in communication with said database, said scanner, and said analyzer;
software executing on said controller for receiving the machine-readable code from said scanner and using it to retrieve an item identity from said database;
software executing on said controller for receiving the forensic element from said analyzer and using it to authenticate the item presented for verification using information from said database; and
software executing on said controller for receiving tracking data when the physical item is scanned, and verifying the tracking data using information from said database.

11. The system of claim 10, wherein the analyzer collects tracking data of the item presented for verification at the time it is analyzed.

12. The system of claim 11, further comprising:
software executing on said controller for receiving the tracking data when the physical item is analyzed, and verifying the tracking data using information from said database.

13. The system of claim 12, wherein the information defining time, date, and location parameters includes a date and a location, and the physical item is permitted to be in the location on the date.

14. The system of claim 12, wherein the information defining time, date, and location parameters includes a list of locations, and the physical item is permitted to be in any location on the list of locations on any date.

15. The system of claim 12, wherein the information defining time, date, and location parameters includes a date range, and the physical item is permitted to be in any location during the date range.

16. The system of claim 12, wherein the tracking data includes the current date, time, and location of the item presented for verification.

17. A method of tracking and authenticating an item, comprising the steps of:
a first user creating a digital file and storing it in a database, the digital file having information that associates a physical item with a machine-readable code, a forensic element, and parameters for at least one of time, date, and location data;
transmitting the digital file from the database to a device where it is used to mark the physical item with the machine-readable code and the forensic element corresponding to the physical item;
the first user transferring the physical item to a second user;
the second user scanning the physical item with a scanner that sends information including the scanned machine-readable code and tracking data of the physical item to a controller where software executing on the controller authenticates the physical item by comparing the information received from the scanner with information in a digital file corresponding to the physical item obtained from the database;
the second user analyzing the physical item with an analyzer that sends information including the analyzed forensic element to the controller where software executing on the controller authenticates the physical item by comparing the information received from the analyzer with information in the digital file corresponding to the physical item obtained from the database.
